(19) United States
(12) Patent Application Publication
(10) Pub. No.: US 2016/0148518 A1
(43) Pub. Date: May 26, 2016

(54) ADAPTABLE BIBLE TEACHING SOUND BOARD DEVICE

(71) Applicant: Clyde R. Yost, JR., Castalia, OH (US)

(72) Inventor: Clyde R. Yost, JR., Castalia, OH (US)

(21) Appl. No.: 14/548,898

(22) Filed: Nov. 20, 2014

(51) Int. Cl. G09B 5/04; G09B 19/00

(52) U.S. Cl. CPC G09B 5/04; G09B 19/00

(57) ABSTRACT

An adaptable Bible teaching sound board device facilitates teaching of the books of the Bible using changeable periodic reward sounds and songs combined with sequentially presented book related sounds. The device includes a processor, a speaker, and a memory unit coupled to a housing. Each of a plurality of book buttons coupled the housing corresponds to a respective book of the Bible. Each of a plurality of book sound records stored on the memory unit is broadcast through the speaker by the processor upon manipulation of the book buttons. Reward buttons coupled to the housing are operationally coupled to the processor and actuate a plurality of reward sound records. A communications port is communicatively coupled to the processor and the memory unit for customization of the reward sound records on the memory unit.

### BACKGROUND OF THE DISCLOSURE

### Field of the Disclosure

The disclosure relates to sound board devices and more particularly pertains to a new sound board device for facilitating teaching of the books of the Bible using changeable periodic reward sounds combined with sequentially presented book related sounds.

### SUMMARY OF THE DISCLOSURE

An embodiment of the disclosure meets the needs presented above by generally comprising a processor, a speaker, and a memory unit coupled to a housing. Each of a plurality of book buttons coupled the housing corresponds to a respective book of the Bible. Each of a plurality of book sound records stored on the memory unit is broadcast through the speaker by the processor upon manipulation of the book buttons. Reward buttons coupled to the housing are operationally coupled to the processor and actuate a plurality of reward sound records. A communications port is communicatively coupled to the processor and the memory unit for customization of the reward sound records on the memory unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of an adaptable bible teaching sound board device according to an embodiment of the disclosure.

FIG. 2 is a bottom view of an embodiment of the disclosure.

FIG. 3 is a top view of an embodiment of the disclosure.

FIG. 4 is a schematic view of an embodiment of the disclosure.

### DESCRIPTION OF THE PREFERRED EMBODIMENT

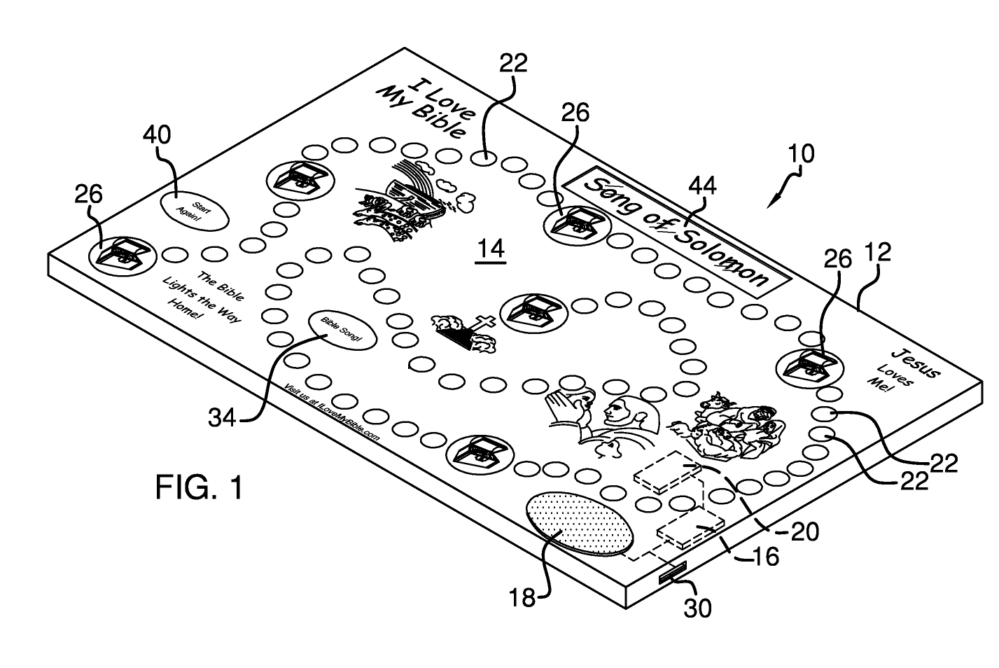

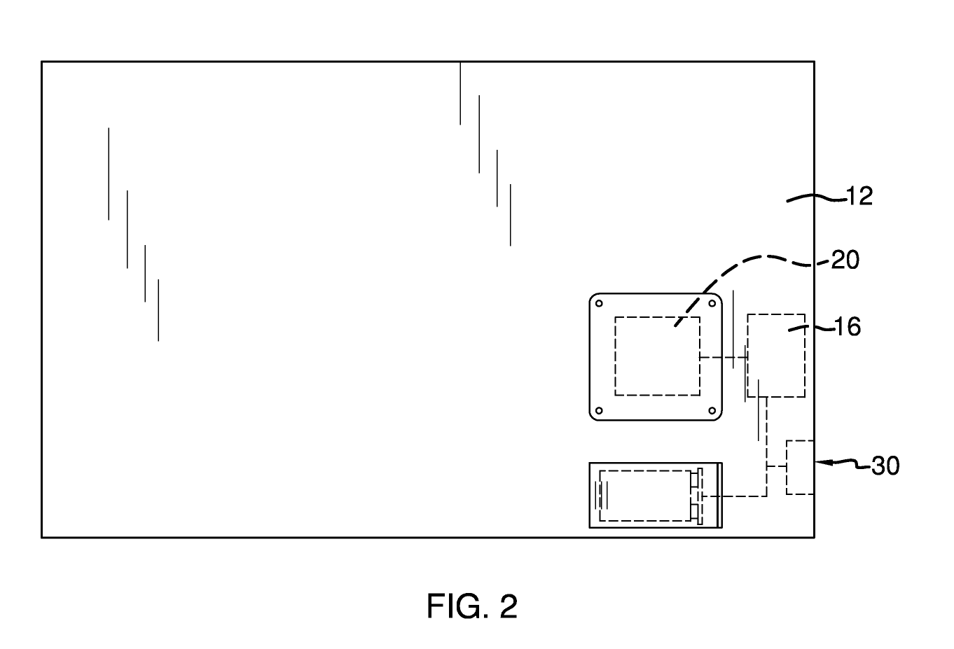

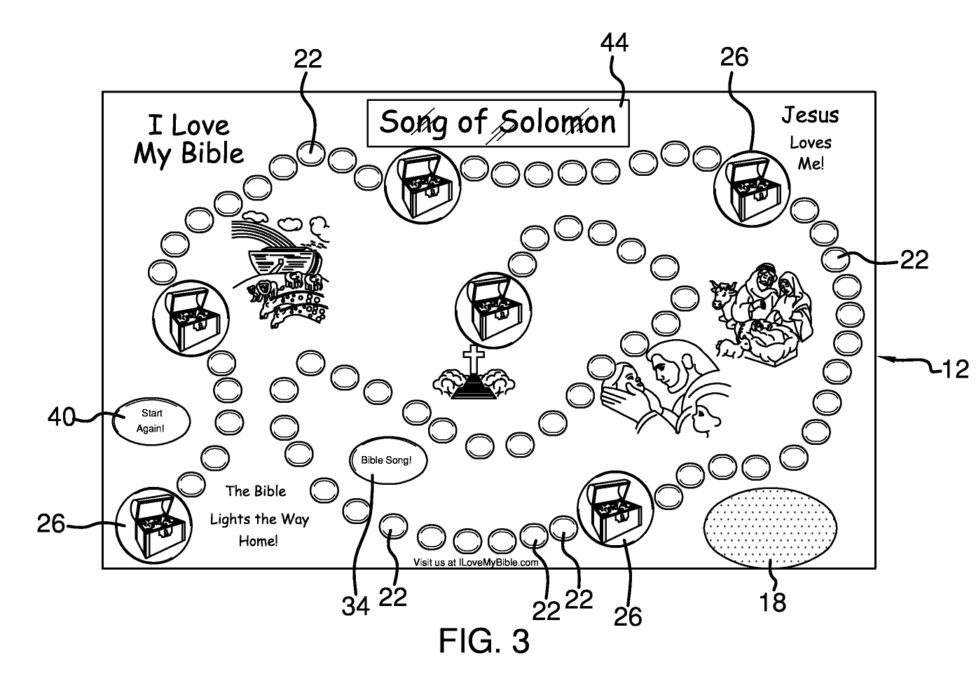

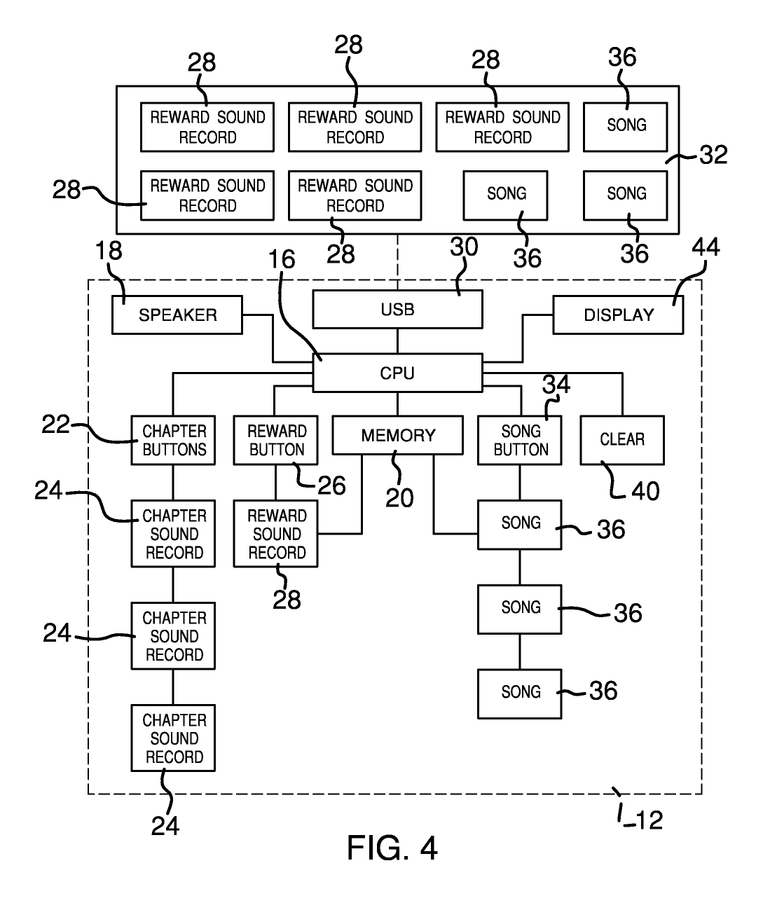

With reference now to the drawings, and in particular to FIGS. 1 through 4 thereof, a new sound board device embodying the principles and concepts of an embodiment of the disclosure and generally designated by the reference numeral 10 will be described.

As best illustrated in FIGS. 1 through 4, the adaptable bible teaching sound board device 10 generally comprises a housing 12 having a top face 14. A processor 16 is coupled to the housing 12 and conventionally positioned within the housing 12 such that the processor 16 is encased by the housing 12. A speaker 18 is coupled to the housing 12 and may be positioned on the top face 14. The speaker 18 broadcasts sounds when the speaker 18 is actuated by the processor 16. A memory unit 20 is positioned in the housing 12 and communicatively coupled to the processor 16.

Each of a plurality of book buttons 22 corresponds to a book of the Bible such that there are 66 book buttons 22. The book buttons 22 are not named or marked on the housing 12. Each of the book buttons 22 is operationally coupled to the processor 16. Each of a plurality of book sound records 24 is stored on the memory unit 20. Each of the book sound records 24 is broadcast through the speaker 18 by the processor 16 upon manipulation of an associated one of the book buttons 22. The book buttons 22 are sequentially linked wherein the processor 16 actuates the speaker 18 for manipulation of each book button 22 only when the book buttons 22 are manipulated in a pre-set sequence. A plurality of the book sound records 24 is associated with each book button 22 allowing for broadcast of multiple sounds associated with each book of the Bible. In an embodiment, each book button 22 in the pre-set sequence is pressed multiple times to broadcast each of the book sound records 24 associated with the book button 22 prior to a subsequent book button 22 in the pre-set sequence being pressable to actuate the book sound records 24 associated with the subsequent book button 22. Thus, the sounds for each book of the Bible must be played in sequence. Alternatively, each book button 22 is pressed multiple times to broadcast each of the book sound records 24 associated with the book button 22 but all book buttons 22 are pressable at any desired time such that the book buttons 22 do not have to be pressed in any particular sequence.

Each of a plurality of reward buttons 26 is coupled to the housing 12. Each of the reward buttons 26 is operationally coupled to the processor 16. The reward buttons 26 are interspersed within the pre-set sequence establishing goals to reach by listening to each of the book sound records 24 for the book buttons 22 positioned before the reward button 26 in the pre-set sequence. Each of a plurality of reward sound records 28 is broadcast through the speaker 18 by the processor 16 upon manipulation of an associated one of the reward buttons 26. The reward sound records 28 may indicate congratulations on progress or provide additional information about the Bible. In an embodiment designed to reward sequential movement through the books of the Bible, each of the reward buttons 26 is pres sable to actuate broadcasting of the associated reward sound record 28 only when all the book buttons 22 prior to the reward button 26 have been manipulated to play all associated book sound records 24. In an embodiment of the disclosure, each reward button 26 may be pressed at any time regardless of pressing any other book buttons 22 or reward buttons 26.

A communications port 30 is coupled to the housing 12. The communications port 30 is communicatively coupled to the processor 16 and the memory unit 20. An extrinsic storage unit 32 relative to the housing 12 is provided. A plurality of the reward sound records 28 is stored on the extrinsic storage unit 32. The reward sound records 28 stored on the extrinsic storage unit 32 are accessible for loading to the memory unit 20 through the communications port 30. Thus, reward sound records 28 on the memory unit 20 are variable. The extrinsic memory unit 32 may be a hard drive, a jump drive, or the like. Further, the extrinsic memory unit 32 may be a server accessed through the internet by connection to a web site allowing for selection and customization of the reward sound records 28 downloaded to the memory unit 20.

A song button 34 is coupled to the housing 12. The song button 34 is operationally coupled to the processor 16. A plurality of song records 36 is stored on the memory unit 20. The song records 36 are broadcast through the speaker 18 by the processor 16 upon manipulation of the song button 34. The song button 34 may be independent from the pre-set sequence allowing for playing of the song records at any desired time while using the device 10. A plurality of the song records 36 is stored on the extrinsic storage unit 32. The song records 36 stored on the extrinsic storage unit 32 are accessible in the same manner as the reward sound records 28 for loading to the memory unit 20 through the communications port 30. Thus, song records 36 on the memory unit 20 are also variable.

Each of the book buttons 22 is illuminated upon pressing of the book button 22 when the book buttons 22 are pressed corresponding to the pre-set sequence. A clear button 40 is coupled to the housing 12. The clear button 40 is operationally coupled to the processor 16. Each of the book buttons 22 remains illuminated until manipulation of the clear button 40 allowing a user to start over from the beginning of the pre-set sequence. The book buttons 22 and interspersed reward buttons 26 may be arranged in a circuitous path around the top face 14 of the housing 12.

A display screen 44 is coupled to the housing 12 and positioned on the top face 14. The display screen 44 displays a book name corresponding to each book button 22 upon manipulation of the book button 22. The book name is revealed only when the corresponding book button 22 is manipulated promoting memorization of the sequence of books by preventing a user from simply reading the book name.

In use, the device 10 is activated by way of a conventional power switch. The user presses the book buttons 22 and reward buttons 26 in the proper sequence to hear and learn facts about the Bible.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. An adaptable Bible teaching sound board device comprising:
a housing having a top face;
a processor coupled to said housing;
a speaker coupled to said housing, said speaker broadcasting sounds when said speaker is actuated by said processor;
a plurality of book buttons coupled to said top face of said housing, each of said book buttons being operationally coupled to said processor, each of said book buttons corresponding to a book of the Bible;
a memory unit, said memory unit being communicatively coupled to said processor;
a plurality of book sound records stored on said memory unit, each of said book sound records being broadcast through said speaker by said processor upon manipulation of an associated one of said book buttons;
a communications port coupled to said housing, said communications port being communicatively coupled to said processor and said memory unit;
a plurality of reward buttons coupled to said housing, said reward buttons being operationally coupled to said processor; and
a plurality of reward sound records, each of said reward sound records being broadcast through said speaker by said processor upon manipulation of an associated one of said reward buttons.

2. The device of claim 1, further comprising:
an extrinsic storage unit relative to said housing; and
a plurality of said reward sound records being stored on said extrinsic storage unit, said reward sound records stored on said extrinsic storage unit being accessible for loading to said memory unit through said communications port wherein reward sound records on said memory unit are variable.

3. The device of claim 1, further comprising:
a song button coupled to said housing, said song button being operationally coupled to said processor; and
a plurality of song records stored on said memory unit, said song records being broadcast through said speaker by said processor upon manipulation of said song button.

4. The device of claim 3, further comprising:
an extrinsic storage unit relative to said housing; and
a plurality of said song records being stored on said extrinsic storage unit, said song records stored on said extrinsic storage unit being accessible for loading to said memory unit through said communications port wherein song records on said memory unit are variable.

5. The device of claim 1, further comprising said book buttons being sequentially linked wherein said processor actuates said speaker for manipulation of each said book buttons only when said book buttons are manipulated in a pre-set sequence.

6. The device of claim 5, further comprising a plurality of said book sound records being associated with each said book button, each said book button in said pre-set sequence being pressed multiple times to broadcast each of said book sound records associated with said book button prior to a subsequent said book button in said pre-set sequence being pressable to actuate said book sound records associated with said subsequent book button.

7. The device of claim 6, further comprising said reward buttons being interspersed within said pre-set sequence, each of said reward buttons being pressable to actuate broadcasting of said associated reward sound record only when all said book buttons prior to said reward button have been manipulated to play all associated book sound records.

8. The device of claim 5, further comprising each of said book buttons being illuminated upon pressing of said book button when said book buttons are pressed corresponding to said pre-set sequence.

9. The device of claim 8, further comprising:
a clear button coupled to said housing, said clear button being operationally coupled to said processor; and
each of said book buttons remaining illuminated until manipulation of said clear button.

10. The device of claim 1, further comprising a display screen coupled to said housing, said display screen displaying a book name corresponding to each book button upon manipulation of said book button such that said book name is revealed only when said corresponding book button is manipulated.

11. An adaptable Bible teaching sound board device comprising:
a housing having a top face;
a processor coupled to said housing;
a speaker coupled to said housing, said speaker broadcasting sounds when said speaker is actuated by said processor;
a memory unit, said memory unit being communicatively coupled to said processor;
a plurality of book buttons, each of said book buttons corresponding to a book of the Bible, each of said book buttons being operationally coupled to said processor;
a plurality of book sound records stored on said memory unit, each of said book sound records being broadcast through said speaker by said processor upon manipulation of an associated one of said book buttons, said book buttons being sequentially linked wherein said processor actuates said speaker for manipulation of each said book buttons only when said book buttons are manipulated in a pre-set sequence;
a plurality of reward buttons coupled to said housing, each of said reward buttons being operationally coupled to said processor, said reward buttons being interspersed within said pre-set sequence;
a plurality of reward sound records, each of said reward sound records being broadcast through said speaker by said processor upon manipulation of an associated one of said reward buttons;
a communications port coupled to said housing, said communications port being communicatively coupled to said processor and said memory unit;
an extrinsic storage unit relative to said housing;
a plurality of said reward sound records being stored on said extrinsic storage unit, said reward sound records stored on said extrinsic storage unit being accessible for loading to said memory unit through said communications port wherein reward sound records on said memory unit are variable;
a song button coupled to said housing, said sound button being operationally coupled to said processor;
a plurality of song records stored on said memory unit, said song records being broadcast through said speaker by said processor upon manipulation of said song button;
a plurality of said song records being stored on said extrinsic storage unit, said song records stored on said extrinsic storage unit being accessible for loading to said memory unit through said communications port wherein song records on said memory unit are variable;
a plurality of said book sound records being associated with each said book button, each said book button in said pre-set sequence being pressed multiple times to broadcast each of said book sound records associated with said book button prior to a subsequent said book button in said pre-set sequence being pressable to actuate said book sound records associated with said subsequent book button;
each of said reward buttons being pressable to actuate broadcasting of said associated reward sound record only when all said book buttons prior to said reward button have been manipulated to play all associated book sound records;
each of said book buttons being illuminated upon pressing of said book button when said book buttons are pressed corresponding to said pre-set sequence;
a clear button coupled to said housing, said clear button being operationally coupled to said processor, each of said book buttons remaining illuminated until manipulation of said clear button; and
a display screen coupled to said housing, said display screen displaying a book name corresponding to each book button upon manipulation of said book button such that said book name is revealed only when said corresponding book button is manipulated.

12. An adaptable Bible teaching sound board device comprising:
a housing having a top face;
a processor coupled to said housing;
a speaker coupled to said housing, said speaker broadcasting sounds when said speaker is actuated by said processor;
a memory unit, said memory unit being communicatively coupled to said processor;
a plurality of book buttons, each of said book buttons corresponding to a book of the Bible, each of said book buttons being operationally coupled to said processor;
a plurality of book sound records stored on said memory unit, each of said book sound records being broadcast through said speaker by said processor upon manipulation of an associated one of said book buttons;
a plurality of reward buttons coupled to said housing, each of said reward buttons being operationally coupled to said processor;
a plurality of reward sound records, each of said reward sound records being broadcast through said speaker by said processor upon manipulation of an associated one of said reward buttons;
a communications port coupled to said housing, said communications port being communicatively coupled to said processor and said memory unit;
an extrinsic storage unit relative to said housing;
a plurality of said reward sound records being stored on said extrinsic storage unit, said reward sound records stored on said extrinsic storage unit being accessible for loading to said memory unit through said communications port wherein reward sound records on said memory unit are variable;
a song button coupled to said housing, said sound button being operationally coupled to said processor;
a plurality of song records stored on said memory unit, said song records being broadcast through said speaker by said processor upon manipulation of said song button;
a plurality of said song records being stored on said extrinsic storage unit, said song records stored on said extrinsic storage unit being accessible for loading to said memory unit through said communications port wherein song records on said memory unit are variable;
a plurality of said book sound records being associated with each said book button, each said book button being pressed multiple times to broadcast each of said book sound records associated with said book button;
each of said book buttons being illuminated upon pressing of said book button when said book buttons are pressed corresponding to said pre-set sequence;
a clear button coupled to said housing, said clear button being operationally coupled to said processor, each of said book buttons remaining illuminated until manipulation of said clear button; and
a display screen coupled to said housing, said display screen displaying a book name corresponding to each book button upon manipulation of said book button such that said book name is revealed only when said corresponding book button is manipulated.
